(19) United States
(12) Patent Application Publication
(10) Pub. No.: US 2024/0281644 A1
(43) Pub. Date: Aug. 22, 2024

(54) ENCODING METHOD AND ENCODING CIRCUIT

(71) Applicant: MACRONIX INTERNATIONAL CO., LTD., Hsinchu (TW)

(72) Inventors: Tzu-Hsiang SU, Hsinchu City (TW); Jeng-Lun SHIEH, Taichung City (TW); Shanq-Jang RUAN, New Taipei City (TW)

(21) Appl. No.: 18/323,473

(22) Filed: May 25, 2023

Related U.S. Application Data
(60) Provisional application No. 63/447,354, filed on Feb. 22, 2023.

(51) Int. Cl. G06N 3/048

(52) U.S. Cl. CPC G06N 3/048

(57) ABSTRACT

The application provides an encoding method and an encoding circuit. The encoding method includes: performing linear conversion on an input into a first vector based on a weight by a convolution layer; comparing the first vector generated from the convolution layer with a reference value to generate a second vector by an activation function; binding the second generated by the activation function with a random vector to generate a plurality of binding results; adding the binding results to generate an adding result; and operating the adding result by a Signum function and a normalization function to generate an output vector.

This application claims the benefit of U.S. provisional application Ser. No. 63/447,354, filed Feb. 22, 2023, the subject matter of which is incorporated herein by reference.

### TECHNICAL FIELD

The disclosure relates in general to an encoding method and an encoding circuit.

### BACKGROUND

Recently, more and more AI researchers adopt feature vector learning and thus the cost of feature storing and feature searching in IMS (in-memory searching) memory is also rapidly increased.

Many proposals have been made to reduce the cost of feature storing and feature searching in IMS memory. Most of the proposals rely on quantifying 32-bit floating point features (FP32) into binary features, in order to reduce feature storing and feature searching cost in IMS.

One of common binary quantization methods is hyperdimensional computing methodology. Hyperdimensional computing methodology random generates hyper feature vectors for encoding. Hyperdimensional computing methodology has high efficiency but limited capacity. Therefore, Hyperdimensional computing methodology still has room for improvements.

### SUMMARY

According to one embodiment, an encoding method is provided. The encoding method includes: performing linear conversion on an input into a first vector based on a weight by a convolution layer; comparing the first vector generated from the convolution layer with a reference value to generate a second vector by an activation function; binding the second generated by the activation function with a random vector to generate a plurality of binding results; adding the binding results to generate an adding result; and operating the adding result by a Signum function and a normalization function to generate an output vector.

According to another embodiment, provided is an encoding circuit coupled to a memory device. The encoding circuit comprises: a convolution layer circuit coupled to the memory device for performing linear conversion on an input from the memory device into a first vector based on a weight from the memory device; an activation circuit coupled to the convolution layer circuit for comparing the first vector generated from the convolution layer circuit with a reference value to generate a second vector; a binding circuit coupled to the activation circuit for binding the second generated by the activation function circuit with a random vector from the memory device to generate a plurality of binding results; an adding circuit coupled to the binding circuit for adding the binding results to generate an adding result; and a Signum function and normalization circuit coupled to the adding circuit for operating the adding result by a Signum function and a normalization function to generate an output vector, wherein the output vector is written into the memory device.

### BRIEF DESCRIPTION OF THE DRAWINGS

FIG. 1 shows an encoder according to one embodiment of the application.

FIG. 2 shows a hardware structure of an encoding circuit according to one embodiment of the application.

In the following detailed description, for purposes of explanation, numerous specific details are set forth in order to provide a thorough understanding of the disclosed embodiments. It will be apparent, however, that one or more embodiments may be practiced without these specific details. In other instances, well-known structures and devices are schematically shown in order to simplify the drawing.

### DESCRIPTION OF THE EMBODIMENTS

Technical terms of the disclosure are based on general definition in the technical field of the disclosure. If the disclosure describes or explains one or some terms, definition of the terms is based on the description or explanation of the disclosure. Each of the disclosed embodiments has one or more technical features. In possible implementation, one skilled person in the art would selectively implement part or all technical features of any embodiment of the disclosure or selectively combine part or all technical features of the embodiments of the disclosure.

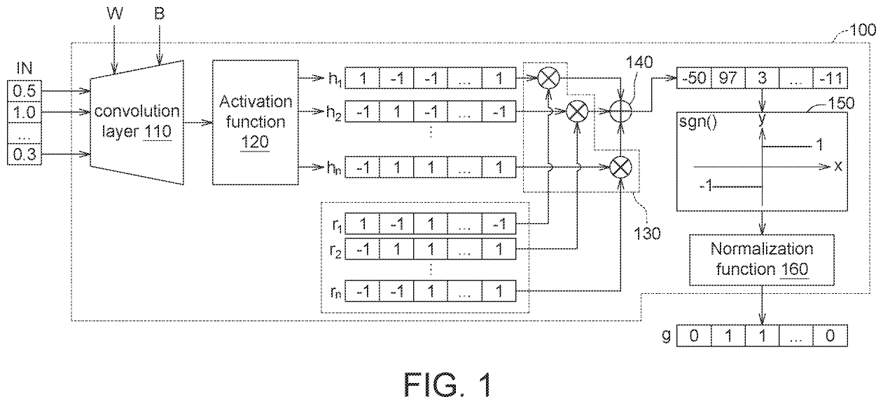

FIG. 1 shows an encoder according to one embodiment of the application. The encoder 100 may implement an encoding method according to one embodiment of the application. As shown in FIG. 1, the encoder 100 includes: a convolution layer 110, an activation function 120, a binder 130, an adder 140, a Signum function 150 and a normalization function 160. The encoder 100 encodes an input IN into a binary vector g.

The convolution layer 110 performs linear conversion on the input IN according to a plurality of weights W and a plurality of bias values B (the bias values B are optional) into a vector. For example but not limited by, the input IN is a 32-bit floating input. The convolution layer 110 performs linear conversion on the input IN according to the plurality of weights W and the plurality of bias values B into a floating vector. In one example of the application, parameters of the convolution layer 110 may be set as: stride=1, input=n, output=d. The parameter “Stride” is a moving distance in each Kernel calculation of the convolution layer. The parameter “input” is the vector length of the input data of the convolution layer. The parameter “output” is the vector length of the output data of the convolution layer.

The activation function 120 performs comparison by comparing the floating vector from the convolution layer 110 with a reference value (for example but not limited by 0) to generate a binary vector. In one example of the application, in a training stage, the activation function 120 is for example but not limited by a hyperbolic tangent function; and in an inference stage, the activation function 120 is for example but not limited by a Signum function.

For example, an example is described wherein the IN is 32-bit floating point input and the convolution layer 110 is an one-dimension convolution layer (1×d, wherein d=32). After linear conversion by the convolution layer 110 and comparison by the activation function 120, a first 32-bit floating point input IN (having a value of “0.5”) is converted (i.e. quantized) into a binary vector h₁, h₁=[1 −1 −1 . . . 1] and others are so on. In FIG. 1, “n” refers to the number of the input IN.

The binder 130 binds the binary vectors [h₁, . . . , hₙ] generated from the activation function 120 with a plurality of random vectors [r₁, . . . , rₙ] to generate a plurality of binding results.

The adder 140 adds the plurality of binding results generated by the binder 130 to generate an adding result. In one example of the application, the binder 130 is for example but not limited by an XOR logic operation.

The Signum function 150 and the normalization function 160 may operate or process the adding result from the adder 140 by the following (which is not to limit the application) to generate the binary vector g.

$$g = \frac{sgn ( {⊕}_{i = 1}^{n} {h}_{i}^{′} ) + 1}{2} = \frac{sgn ( {\sum }_{i = 1}^{n} {h}_{i}^{′} ) + 1}{2} , {h}_{i}^{′} = {h}_{i} ⊗ {r}_{i} ,$$

The Signum function 150 may have the following operations, wherein “x” refers to values of the adding result from the adder 140 and “y” refers to the output from the Signum function 150: y=1 when x>0; and y=−1 when x<0.

The normalization function 160 normalizes the output from the Signum function 150. For example but not limited by, when the output from the Signum function 150 is “1”, the normalization function 160 normalizes the output (“1”) from the Signum function 150 as “1”; and when the output from the Signum function 150 is “−1”, the normalization function 160 normalizes the output (“−1”) from the Signum function 150 as “0”.

By so, the Signum function 150 and the normalization function 160 may lower the dimension of the adding result from the adder 140.

The binary vector g may be optionally stored in a memory device for similarity search and the like.

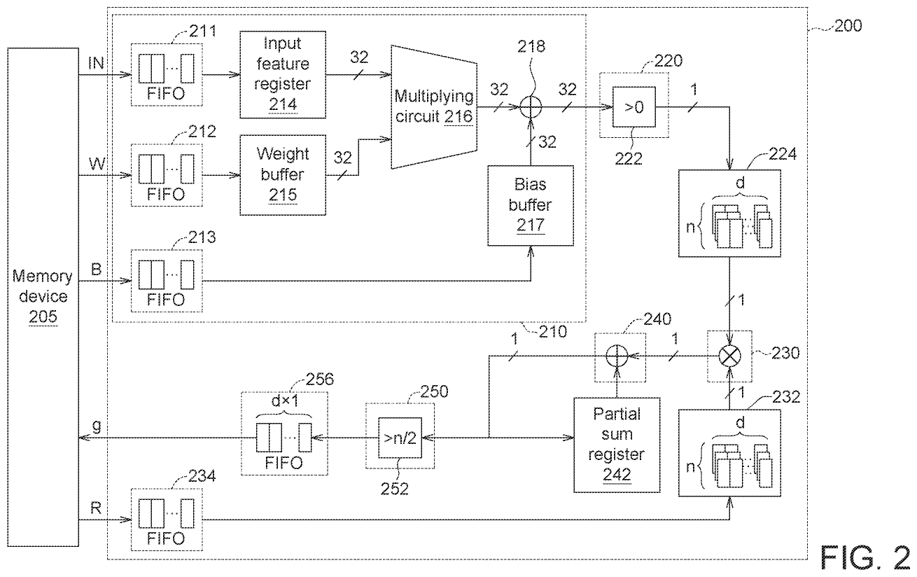

FIG. 2 shows a hardware structure of an encoding circuit according to one embodiment of the application. The encoding circuit 200 may be used to implement the encoder 100 of FIG. 1. As shown in FIG. 2, the encoding circuit 200 includes: a convolution layer circuit 210, an activation circuit 220, a binding circuit 230, an adding circuit 240, and a Signum function and normalization circuit 250. The encoding circuit may encode the input IN into the binary vector. The encoding circuit 200 further includes an output buffer 224. The convolution layer circuit 210, the activation circuit 220, the binding circuit 230, the adding circuit 240, and the Signum function and normalization 250 may be used to implement the convolution layer 110, the activation function 120, the binder 130, the adder 140, the Signum function 150 and the normalization function 160.

The convolution layer circuit 210 is coupled to the memory device 205. The convolution layer circuit 210 includes a plurality of FIFO (first-in-first-out) circuits 211˜213, an input feature register 214, a weight buffer 215, a multiplying circuit 216, a bias buffer 217 and an adding circuit 218.

The FIFO circuits 211˜213 are coupled to the memory device 205. The memory device is for example but not limited by a dynamic random access memory (DRAM). The input IN, the weights W and the bias values B read from the memory device 205 are stored in the FIFO circuits 211˜213. The FIFO circuits 211 and 212 output the registered input IN and the registered weights W to the input feature register 214 and the weight buffer 215. The input feature register 214 and the weight buffer 215 output the registered input IN and the registered weights W to the multiplying circuit 216 for multiplication; and the multiplying circuit 216 sends the multiplying result to the adding circuit 218. The FIFO circuit 213 outputs the registered bias values B to the bias buffer 217. The bias buffer 217 outputs the registered bias values B to the adding circuit 218. The adding circuit 218 adds the multiplying result from the multiplying circuit 216 with the bias values B to generate the floating point vectors.

When the input IN is 32-bit floating point values, the input feature register 214 is 32-bit, the weight buffer 215 is (d×32)-bit, the multiplying circuit 216 is a 32-bit floating point multiplier, the bias buffer 217 is (d×32)-bit and the adding circuit 218 is a 32-bit floating point adder.

The activation circuit 220 is coupled to the convolution layer circuit 210. The activation circuit 220 performs comparison to compare the floating vectors generated by the convolution layer circuit 210 with a reference value (for example but not limited by 0) to generate a binary vector. In one example of the application, for example but not limited by, when the input IN is 32-bit floating point input, the activation circuit 220 includes a 32-bit floating point comparator 222. In details, when the 32-bit floating vector generated by the convolution layer circuit 210 has a value larger than 0, the activation circuit 220 outputs “1”; and when the 32-bit floating vector generated by the convolution layer circuit 210 has a value smaller than 0, the activation circuit 220 outputs “−1”.

The binary vectors [h₁, . . . , hₙ] generated by the activation circuit 220 is input into the output buffer 224. The output buffer 224 outputs the registered binary vectors [h₁, . . . , hₙ] to the binding circuit 230. For example but not limited by, during a training stage, the activation circuit 220 performs a hyperbolic tangent function; and in an inference stage, the activation circuit 220 performs for example but not limited by a Signum function.

The random vectors R read from the memory device 205 are registered in the FIFO circuit 234 and the FIFO circuit 234 sends the random vectors R to the random vector buffer 232.

The binding circuit 230 is coupled to the output buffer 224. The binding circuit 230 binds the binary vectors [h₁, . . . , hₙ] from the activation circuit 220 with the random vectors R(R=[r₁, . . . , rₙ]) output from the random vector buffer 232. In one example, the binding circuit 230 is for example but not limited by an XOR logic gate.

The adding circuit 240 is coupled to the binding circuit 230. The adding circuit 240 adds the binding result generated by the binding circuit 230 with the partial sum generated by the partial sum register 242 to generate an adding result. The partial sum register 242 is for summing a series of sums of elements of a given sequence. The first sum is equal to the first element; the second sum is equal to the first element added to the second element; the third sum is equal to the sum of the first three elements, and so on. In FIG. 2, the partial sum register 242 is for summing the adding result from the adding circuit 240.

The Signum function and normalization circuit 250 is coupled to the adding circuit 240. In one example, the Signum function and normalization circuit 250 includes an integer comparator 252. The integer comparator 252 compares the adding result generated by the circuit 240 with a reference integer (for example but not limited by n/2) for performing Signum function and normalization. For example but not limited by, when the adding result is larger than the reference integer (n/2), the integer comparator 252 of the Signum function and normalization circuit 250 outputs “1”; and when the adding result is smaller than the reference integer (n/2), the integer comparator 252 of the Signum function and normalization circuit 250 outputs “0”.

The Signum function and normalization circuit 250 is coupled to the adding circuit 240 and the FIFO circuit 256. The FIFO circuit 256 is for example but not limited by, “d×1” bits. The FIFO circuit 256 registers the output from the Signum function and normalization circuit 250 as the binary vector g for writing into the memory device 205. The binary vector g stored in the memory device 205 may be used in similarity search and the like.

As shown in FIG. 2, by the encoding circuit 200, the input IN is encoded into the binary vector g.

One embodiment of the application discloses trainable hypervector (THV) and high dimension feature vectors are generated by deep learning AI models. Thus, one embodiment of the application may effectively quantize the floating point data into binary vectors for solving conventional high dimension computing issues and improving quantization accuracy.

Still further, one embodiment of the application may be used in any application which needs to convert floating point features (i.e. the floating point input IN) into binary features (i.e. the binary vectors g), for example but not limited by, facial recognition, image retrieval, 2D/3D place recognition, recommendation system and so on.

While this document may describe many specifics, these should not be construed as limitations on the scope of an invention that is claimed or of what may be claimed, but rather as descriptions of features specific to particular embodiments. Certain features that are described in this document in the context of separate embodiments can also be implemented in combination in a single embodiment. Conversely, various features that are described in the context of a single embodiment can also be implemented in multiple embodiments separately or in any suitable sub-combination. Moreover, although features may be described above as acting in certain combinations and even initially claimed as such, one or more features from a claimed combination in some cases can be excised from the combination, and the claimed combination may be directed to a sub-combination or a variation of a sub-combination. Similarly, while operations are depicted in the drawings in a particular order, this should not be understood as requiring that such operations be performed in the particular order shown or in sequential order, or that all illustrated operations be performed, to achieve desirable results.

Only a few examples and implementations are disclosed. Variations, modifications, and enhancements to the described examples and implementations and other implementations can be made based on what is disclosed.

What is claimed is:

1. An encoding method, comprising:
performing linear conversion on an input into a first vector based on a weight by a convolution layer;
comparing the first vector generated from the convolution layer with a reference value to generate a second vector by an activation function;
binding the second generated by the activation function with a random vector to generate a plurality of binding results;
adding the binding results to generate an adding result; and
operating the adding result by a Signum function and a normalization function to generate an output vector.

2. The encoding method according to claim 1, wherein the convolution layer performs linear conversion on the input into the first vector based on the weight and a bias value.

3. The encoding method according to claim 1, wherein
when the input is a 32-bit floating point input, the first vector is a floating point vector; and
the second vector and the output vector are both binary vectors.

4. The encoding method according to claim 1, wherein
in a training stage, the activation function is a hyperbolic tangent function; and in an inference stage, the activation function is a Signum function.

5. The encoding method according to claim 1, wherein the second vector is bound with the random vector by an XOR logic operation.

6. An encoding circuit coupled to a memory device, the encoding circuit comprising:
a convolution layer circuit coupled to the memory device for performing linear conversion on an input from the memory device into a first vector based on a weight from the memory device;
an activation circuit coupled to the convolution layer circuit for comparing the first vector generated from the convolution layer circuit with a reference value to generate a second vector;
a binding circuit coupled to the activation circuit for binding the second generated by the activation function circuit with a random vector from the memory device to generate a plurality of binding results;
an adding circuit coupled to the binding circuit for adding the binding results to generate an adding result; and
a Signum function and normalization circuit coupled to the adding circuit for operating the adding result by a Signum function and a normalization function to generate an output vector, wherein the output vector is written into the memory device.

7. The encoding circuit according to claim 6, wherein the convolution layer circuit performs linear conversion on the input into the first vector based on the weight and a bias value.

8. The encoding circuit according to claim 6, wherein
when the input is a 32-bit floating point input, the first vector is a floating point vector; and
the second vector and the output vector are both binary vectors.

9. The encoding circuit according to claim 6, wherein
in a training stage, the activation function circuit performs a hyperbolic tangent function; and in an inference stage, the activation function circuit performs a Signum function.

10. The encoding circuit according to claim 6, wherein the binding circuit is an XOR logic gate.
